(19) United States
(12) Patent Application Publication
(10) Pub. No.: US 2013/0271324 A1
(43) Pub. Date: Oct. 17, 2013

(54) SYSTEMS AND METHODS CONFIGURED TO ESTIMATE RECEIVER POSITION USING TIMING DATA ASSOCIATED WITH REFERENCE LOCATIONS IN THREE-DIMENSIONAL SPACE

(71) Applicants: Andrew Sendonaris, Los Gatos, CA (US); Norman F. Krasner, Redwood CIty, CA (US); Haochen Tang, Stanford, CA (US)

(72) Inventors: Andrew Sendonaris, Los Gatos, CA (US); Norman F. Krasner, Redwood CIty, CA (US); Haochen Tang, Stanford, CA (US)

(21) Appl. No.: 13/831,740

(22) Filed: Mar. 15, 2013

Related U.S. Application Data
(60) Provisional application No. 61/625,610, filed on Apr. 17, 2012.

(51) Int. Cl. G01S 5/02

(52) U.S. Cl. CPC G01S 5/02
USPC 342/450

(57) ABSTRACT

Systems, methods and computer program products for determining a position location estimate for a remote receiver based on one or more time-of-arrival measurements transmitted from one or more transmitters and first timing data associated with the one or more transmitters and further associated with one or more reference locations within a reference area of the remote receiver are described.

### CROSS-REFERENCE TO RELATED APPLICATIONS

This application claims priority under 35 U.S.C. §119(e) to co-pending U.S. Provisional Patent Application Ser. No. 61/625,610, filed Apr. 17, 2012, entitled THREE DIMENSIONAL DIGITAL CITY MODEL-BASED RANGE MEASUREMENT ERROR MITIGATION FOR TERRESTRIAL TIME-OF-ARRIVAL WIRELESS POSITIONING SYSTEM, the content of which is hereby incorporated by reference herein in its entirety for all purposes.

### FIELD

This disclosure relates generally to positioning systems. More specifically, but not exclusively, the disclosure relates to systems, methods, and computer program products for estimating receiver position using timing data associated with reference locations in three-dimensional space.

### BACKGROUND OF THE INVENTION

Systems for providing position information are known in the art. For example, radio-bases systems such as LORAN, GPS, GLONASS, and the like have been used to provide position information for persons, vehicles, equipment, and the like. These systems do, however, have limitations associated with factors such as location accuracy, transmitted and received signal levels, radio channel interference and/or channel problems such as multipath, device power consumption, and the like.

Determination of a mobile subscriber's exact location can be quite challenging. If the subscriber is indoors or in an urban area with obstructions, the subscriber's mobile device may not be able to receive signals from GPS satellites and the network may be forced to rely on network-based triangulation/multilateration methods that are less precise. Additionally, if the subscriber is in a multi-story building, knowing only that the subscriber is in the building and not what floor they are on, will result in delays in providing emergency assistance (which could be potentially life-threatening). Clearly, a system that can assist the subscriber's computing device (e.g., a mobile computing device) in speeding up the location determination process, provide more accuracy (including vertical information), and solve some of the challenges of location determination in urban areas and inside buildings is needed.

Accordingly, there is a need for improved positioning systems to address these and/or other problems with existing positioning systems and devices.

### SUMMARY OF THE INVENTION

In accordance with the present disclosure, systems, methods and computer program products (e.g., such products comprising a non-transitory computer usable medium having a computer readable program code embodied therein that is adapted to be executed to implement method steps) are described for determining a position location estimate for a remote receiver based on one or more time-of-arrival measurements transmitted from one or more transmitters and first timing data associated with the one or more transmitters and further associated with one or more reference locations within a reference area of the remote receiver are described.

The systems, methods and computer program products may carry out the following steps: determine an initial position estimate for a remote receiver based on one or more time-of-arrival measurements transmitted from one or more transmitters to the remote receiver; identify first timing data associated with the one or more transmitters and further associated with a first reference location within a predefined distance of the initial position estimate; and determine a first position estimate for the remote receiver based on the one or more time-of-arrival measurements and the first timing data associated with the first reference location.

The systems, methods and computer program products may additionally or alternatively carry out the following steps: determine the initial position estimate based on first and second time-of-arrival measurements transmitted from corresponding first and second transmitters to the remote receiver; identify first and second time corrections associated with the corresponding first and second transmitters and further associated with the first reference location; determine the first position estimate based on the first and second time-of-arrival measurements and the first and second time corrections; identify another set of time corrections associated with the corresponding first and second transmitters and further associated with the second reference location within the predefined distance of the initial position estimate; determine a second position estimate for the remote receiver based on the first and second time-of-arrival measurements and the other set of one or more time corrections associated with the second reference location; and determine that the first position estimate is a better position estimate than the second position estimate when a first result corresponding to a first application of an objective function to the first position estimate is preferred over a second application of the objective function to the second position estimate.

The systems, methods and computer program products may additionally or alternatively carry out the following steps: determine the location of the first reference location; determine the location of a first transmitter from the one or more transmitters; determine a first line-of-sight distance between the first reference location and the first transmitter; estimate a first length of a first signal pathway between the first transmitter and the first reference location; compare the first line-of-sight distance with the first length; estimate, based on the comparison between the first line-of-sight distance and the first length, a first time correction of the one or more time corrections; and cause the first time correction to be stored in a data source.

Various additional aspects, features, and functions are described below in conjunction with the appended Drawings.

### BRIEF DESCRIPTION OF THE DRAWINGS

The present application may be more fully appreciated in connection with the following detailed description taken in conjunction with the accompanying drawings.

FIG. 1A depicts a block diagram illustrating details of a terrestrial location system on which embodiments may be implemented.

FIG. 1B depicts a block diagram illustrating details of a terrestrial location system on which embodiments may be implemented.

FIG. 1C depicts a block diagram illustrating details of a terrestrial location system on which embodiments may be implemented.

FIG. 1D depicts a block diagram illustrating details of a terrestrial location system on which embodiments may be implemented.

FIG. 1E depicts a block diagram illustrating details of a terrestrial location system on which embodiments may be implemented.

FIG. 2A illustrates a block diagram illustrating certain aspects of a terrestrial location/positioning system on which embodiments may be implemented.

FIG. 2B illustrates a block diagram illustrating certain aspects of a terrestrial location/positioning system on which embodiments may be implemented.

FIG. 2C illustrates a block diagram illustrating certain aspects of a terrestrial location/positioning system on which embodiments may be implemented.

FIG. 2D illustrates a block diagram illustrating certain aspects of a terrestrial location/positioning system on which embodiments may be implemented.

FIG. 3 provides a diagram detailing a process for estimating a position of receiver using timing data associated with reference locations in accordance with certain aspects.

FIG. 4 provides a diagram detailing a process for collecting timing data associated with reference locations in accordance with certain aspects.

FIG. 5 illustrates a block diagram illustrating certain aspects of a terrestrial location/positioning system on which embodiments may be implemented.

### DETAILED DESCRIPTION OF THE INVENTION

Various aspects of the invention are described below. It should be apparent that the teachings herein may be embodied in a wide variety of forms and that any specific structure, function, or both, being disclosed herein is merely representative. Based on the teachings herein one skilled in the art should appreciate that any aspect disclosed may be implemented independently of any other aspects and that two or more of these aspects may be combined in various ways. For example, a system may be implemented or a method may be practiced using any number of the aspects set forth herein.

As used herein, the term “exemplary” means serving as an example, instance or illustration. Any aspect and/or embodiment described herein as “exemplary” is not necessarily to be construed as preferred or advantageous over other aspects and/or embodiments.

In the following description, numerous specific details are introduced to provide a thorough understanding of, and enabling description for, the systems and methods described. One skilled in the relevant art, however, will recognize that these embodiments can be practiced without one or more of the specific details, or with other components, systems, and the like. In other instances, well-known structures or operations are not shown, or are not described in detail, to avoid obscuring aspects of the disclosed embodiments.

### Overview

One of the major challenges that ground-based “time-of-arrival” (TOA) positioning systems encounter in urban/indoor environments is the severe wireless signal multipath effect caused by the low-elevation nature of the terrestrial transmitters. Before reaching the positioning receiver, the wireless ranging signal transmitted from the ground base-station is possibly reflected, diffracted and/or scattered by single/multiple surrounding objects (such as buildings and vehicles) and arrives at the receiver with a time delay that may differ significantly from that of the “line-of-sight” (LOS) signal. Measurements of the travel time for the signal between a transmitter and a receiver can be used as an estimate for the distance over which the signal traveled, but that distance is not always an accurate reflection of the LOS distance between the transmitter and the receiver because of the multipath effect. Accordingly, received signals, including direct LOS path and multiple delayed paths, generate difficulties for the receiver to retrieve the earliest arriving LOS signal, as well as estimate its transmission time. This directly causes a range measurement error, based on which a calculated trilateration positioning solution is erroneous as well. In extreme situations, such as dense urban canyon or deep indoor locations, the direct LOS signal is totally attenuated by the objects between the transmitter and the receiver so that it is impossible to obtain an accurate range measurement by investigating the received signal delay profile alone.

To tackle this problem, a Bayesian approach may be used, where a priori knowledge of the receiver's environment obtained based on channel modeling (e.g., signal path characteristics from transmitters to various locations in the environment) is incorporated into the estimation of a position solution for the receiver (e.g., where a maximum likelihood, maximum a posteriori, minimum variance, or other method is used to estimate the position solution for the receiver]. As is further discussed herein, one embodiment of this approach involves a two-step positioning accuracy improvement process that (1) measures timing data (e.g., multipath-induced TOA measurements, or differences between measured TOA signals and LOS signals) transmitted from terrestrial transmitters to hypothesized receiver locations (i.e., “reference locations”), and (2) applies the estimates of range measurements or corresponding errors to improve positioning accuracy. Aspects of these and other approaches are discussed in further detail below.

This disclosure may use various terms, including time(s)-of-arrival (TOA) and range(s). The two terms are related in that “TOA” represents travel time of a signal while “range” represents a distance that can be computed using the TOA and the signal speed (e.g., speed of light). The term “range measurement” may be generally used to refer to TOA data.

Various aspects, features, and functions are described below in conjunction with the appended Drawings. While the details of the embodiments of the invention may vary and still be within the scope of the claimed invention, one of skill in the art will appreciate that the Drawings described herein are not intended to suggest any limitation as to the scope of use or functionality of the inventive aspects. Neither should the Drawings and their description be interpreted as having any dependency or requirement relating to any one or combination of components illustrated in those Drawings.

It is noted that similar numbers are used to designate aspects that share similar characteristics. For example, reference is made to system 100A through system 100E, which each comprise similar components while depicting different embodiments. It is further noted that one number may be used to simultaneously refer to similar aspects. For example, reference to system 100 may refer to any of systems 100A-E.

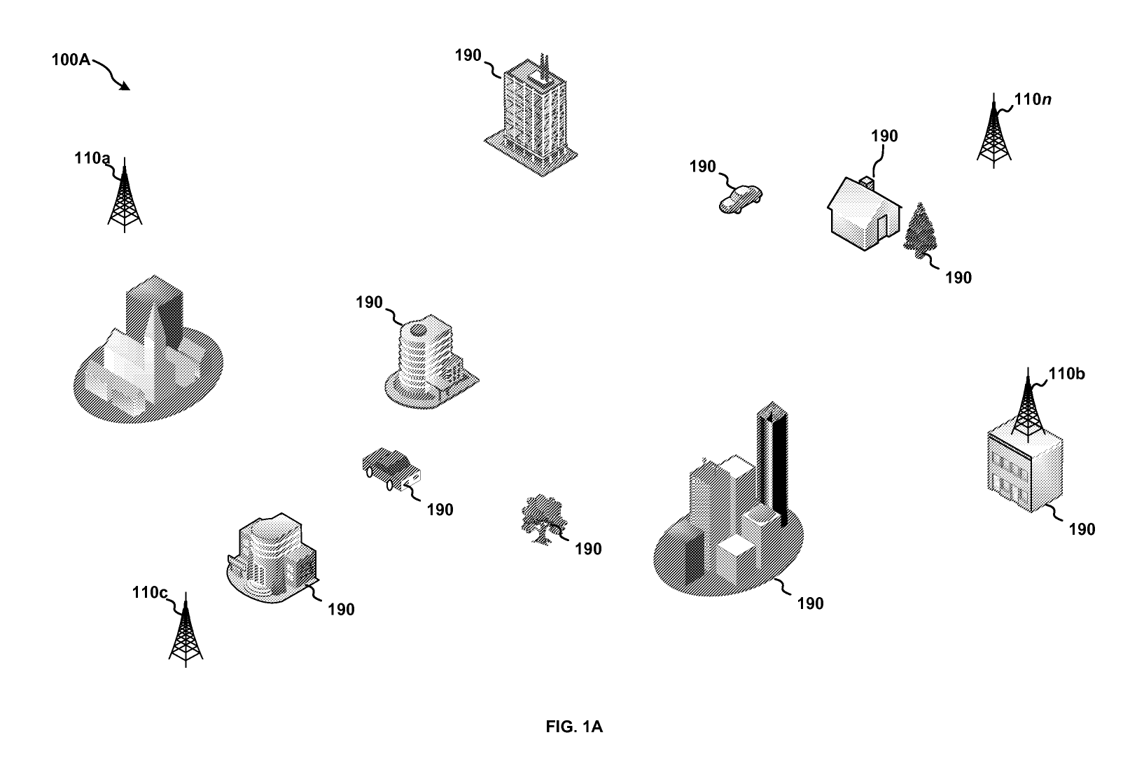

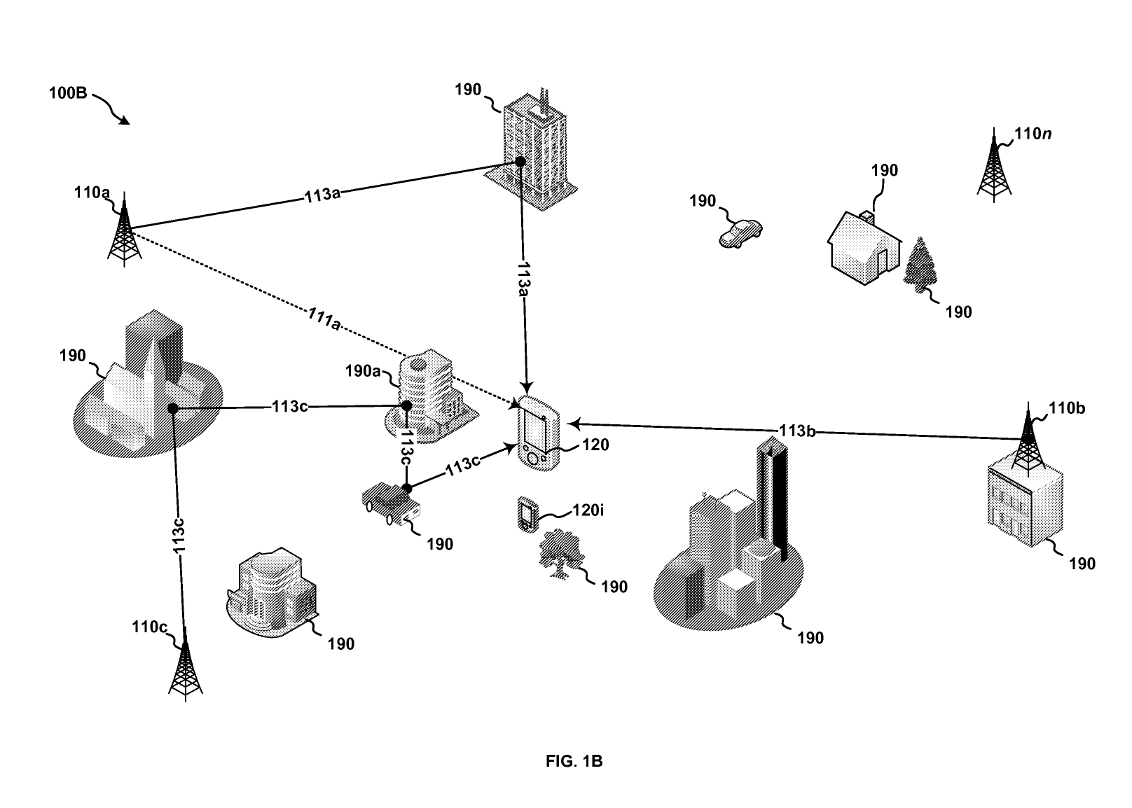

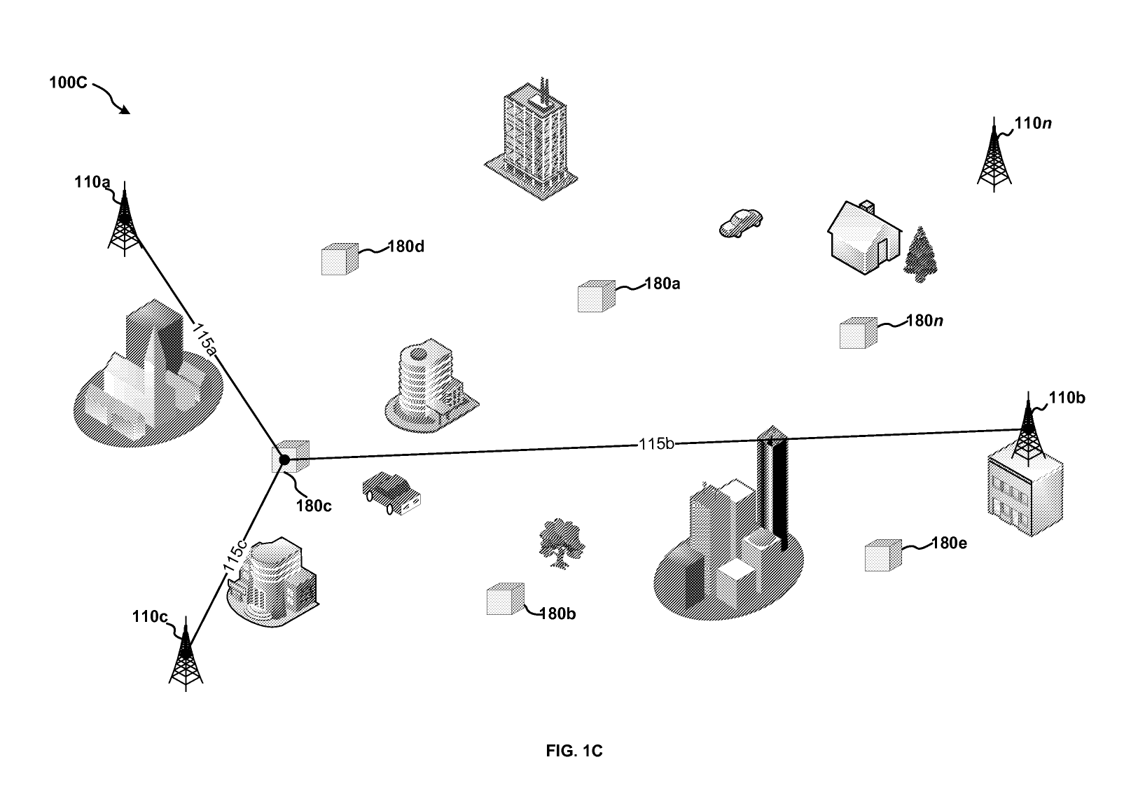

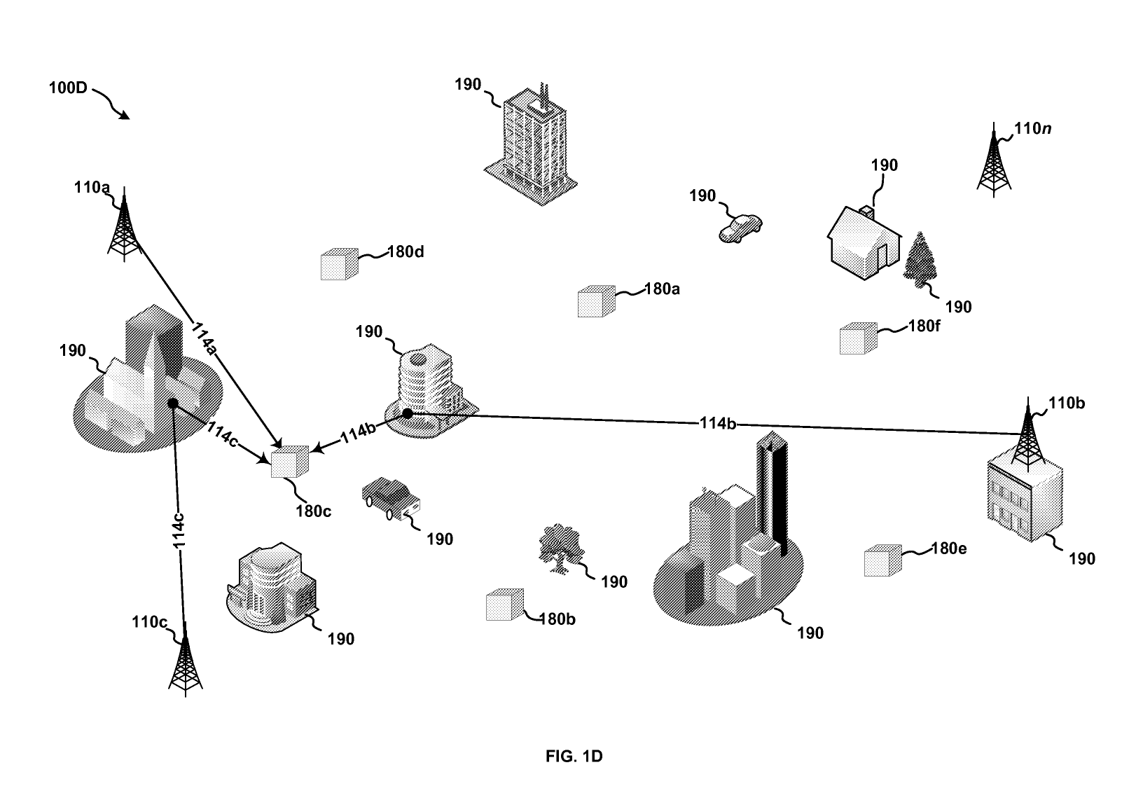

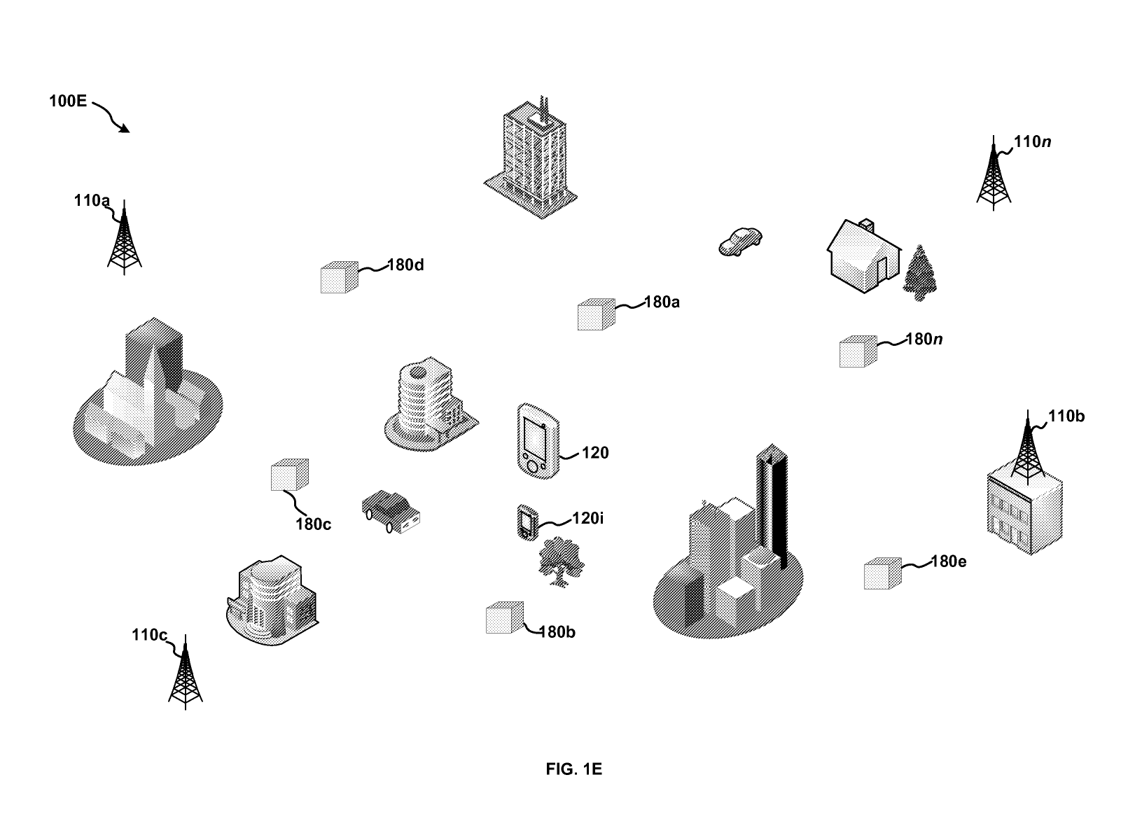

FIG. 1A illustrates details of an example location/positioning system 100A on which various embodiments may be implemented. Positioning system 100, also referred to herein as a Wide Area Positioning System (WAPS), or “system” for brevity, may include a network of synchronized transmitters 110 (also denoted herein as “beacons”), which are typically terrestrial, as well as receivers 120 (also denoted herein as “receiver units” or “ user devices” or “mobile devices” for brevity) configured to acquire and track signals provided from the transmitters 110 and/or other position signaling, such as may be provided by a satellite system such as the Global Positioning System (GPS) and/or other satellite or terrestrially based position systems. The system 100A may further include a server system (not shown) in communication with various other systems, such as the transmitters, a network infrastructure, such as the Internet, cellular networks, wide or local area networks, and/or other networks.

The receiver 120 may optionally include a location computation engine to determine position/location information from signaling received from multiple transmitters 110 via corresponding communication links from each of the transmitters 110. In addition, the receiver 120 may also be configured to receive and/or send other signals, such as, for example, cellular network signals via an appropriate communication link from a cellular base station (also known as a NodeB, eNB, or base station), Wi-Fi network signals, pager network signals, or other wired or wireless connection signaling, as well as satellite signaling via satellite communication links, such as from a GPS or other satellite positioning system.

As illustrated in FIG. 1A, transmitters 110 (e.g., transmitters 110a-n) may be positioned among various terrestrial objects 190 (e.g., man-made objects like buildings and cars, or natural objects like hills, vegetation, and reflective surfaces like water).

Attention is now drawn to FIG. 1B, which depicts a system 100B that, by comparison to system 100A (of FIG. 1A), further comprises a remote computing device (e.g., the receiver 120) located among the various transmitters 110 and terrestrial objects 190. As previously indicated, determining the position of the receiver 120 is often desirable or even needed under certain circumstances. However, in dense urban environments with many objects 190 disposed between the receiver 120 and transmitters 110, a position fix may difficult or poor in performance.

In urban environments, like the one depicted in system 100B, the travel time for a signal is subject to “multipath” delays where the signal does not follow a straight path between the transmitter 110 and the receiver 120, and instead travels around various objects 190, typically by reflections off such objects. By way of example, a signal from transmitter 110a to the receiver 120 may follow a pathway 113a that travels around an object (e.g., object 190a, which blocks a “line-of-sight” pathway 111a between transmitter 110a and the receiver 120). By comparison, the signal pathway 113b from transmitter 110b to the receiver 120 is the unobstructed, and the signal pathway 113c from transmitter 110c to the receiver 120 propagates among various obstructions.

The difference between travel time associated with pathway 111a and 113a, for example, is often referred to as a multipath delay. Multipath delay can account for errors when using signal travel time to estimate a location of the receiver 120. Determining the position of the receiver 120 is made even more difficult when signals from multiple transmitters 110 are multipath signals (e.g., as illustrated by signal pathways 113a and 113c). By way of illustration, an initial position estimate 121i corresponding to the receiver 120 is shown. As illustrated, the initial position estimate 121i has position coordinates that differ from the position coordinates of the actual location at which the receiver 120 resides. As will be further clarified below, better position estimates may be determined using various techniques disclosed herein, including use of spatially-distributed reference locations where timing data (e.g., time-of-arrival measurements) associated with the transmitters 110 are known, or estimated.

Attention is now drawn to FIG. 1C, which depicts a system 100C that, with by comparison to system 100A of FIG. 1A, further designates reference locations 180 (reference locations 180a-n) that are distributed at particular coordinates—e.g., in terms of latitude, longitude and/or height—among objects 190 and transmitters 110. Reference location 180c, for example, is separated from transmitters 110a-c by corresponding line-of-sight distances 115a-c as can be measured using known coordinates of transmitters 110a-c and known coordinates of location 180c. Additional features of reference locations 180 are further described below with respect to FIG. 1D and elsewhere in this disclosure.

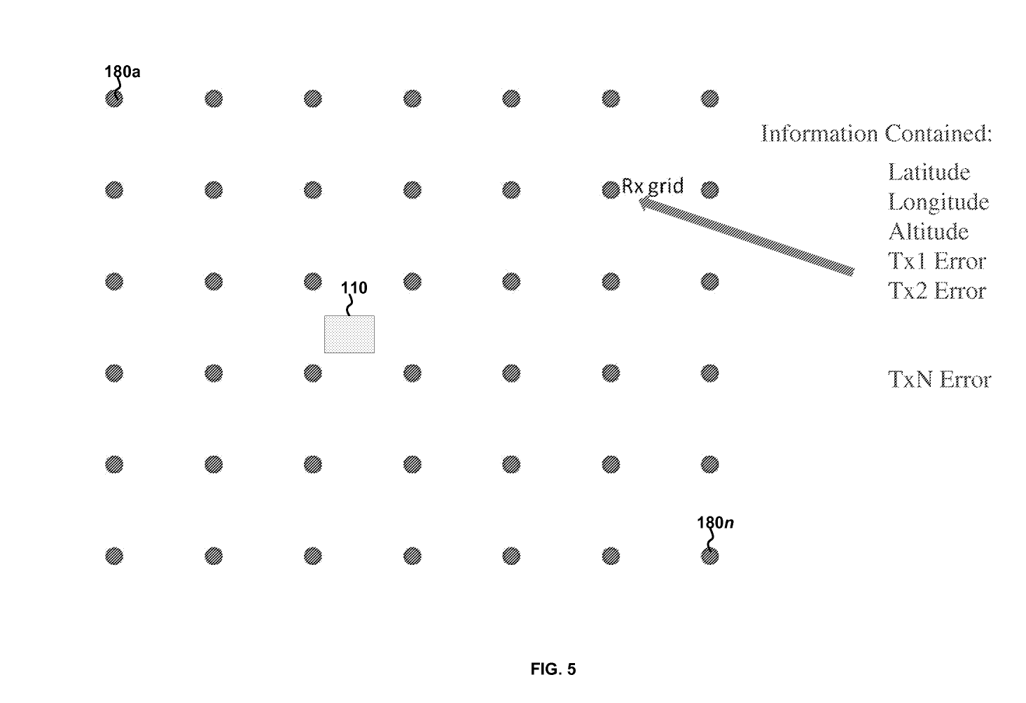

One of skill in the art will appreciate that reference locations may be uniformly distributed on a fairly tight grid (e.g., as illustrated by FIG. 5), or may be non-uniformly distributed (e.g., where the objects 190 do not permit uniform gridding, or where particular reference locations that do not reside at a point on a uniform grid are more commonly occupied by receivers). In at least some cases, the reference locations are selected so that at least one reference location is close to a receiver during estimation of that receiver's position, otherwise the multipath error corresponding to the reference locations will not be useful for the majority of locations.

Attention is now drawn to FIG. 1D, which illustrates signal pathways 114a-c from corresponding transmitters 110a-c to reference location 180c. A temporary or permanent receiver (not shown) may be configured at reference location 180c to measure times-of-arrival (TOA) for various signals from corresponding transmitters 110a-c. Alternatively, such times-of-arrival may be predicted using propagation models together with a database of building and other obstructions within a geographical region. The TOA measurements may be used to determine lengths of signal pathways 114a-c as the respective signals propagate around the various objects 190 on their way to reference location 180c. The TOA measurements may be recorded in a data source (not shown), which may be accessible to the receiver 120. Other types of timing data may be computed and recorded. For example, a multipath delay error may be computed by taking the difference between the line-of-sight distances 115a-c and the distances associated with the signal pathways 114a-c. As illustrated, the signal pathway 114a equals the line-of-sight distance 115a, so a multipath delay error associated with transmitter 110a and reference location 180c would be zero.

Similar timing data may be stored for each of reference locations 180a-n with respect to each of transmitters 110a-n. Resultant TOA measurements and corresponding multipath delay errors may be stored in a data source (not shown) that may be accessible at later times by one or more processing components (not shown, but potentially including one or more processing components at the receiver 120 or a remote server in wireless communication with the receiver 120).

For illustration, FIG. 1E depicts a system 100E which effectively combines systems 100B and 100C.

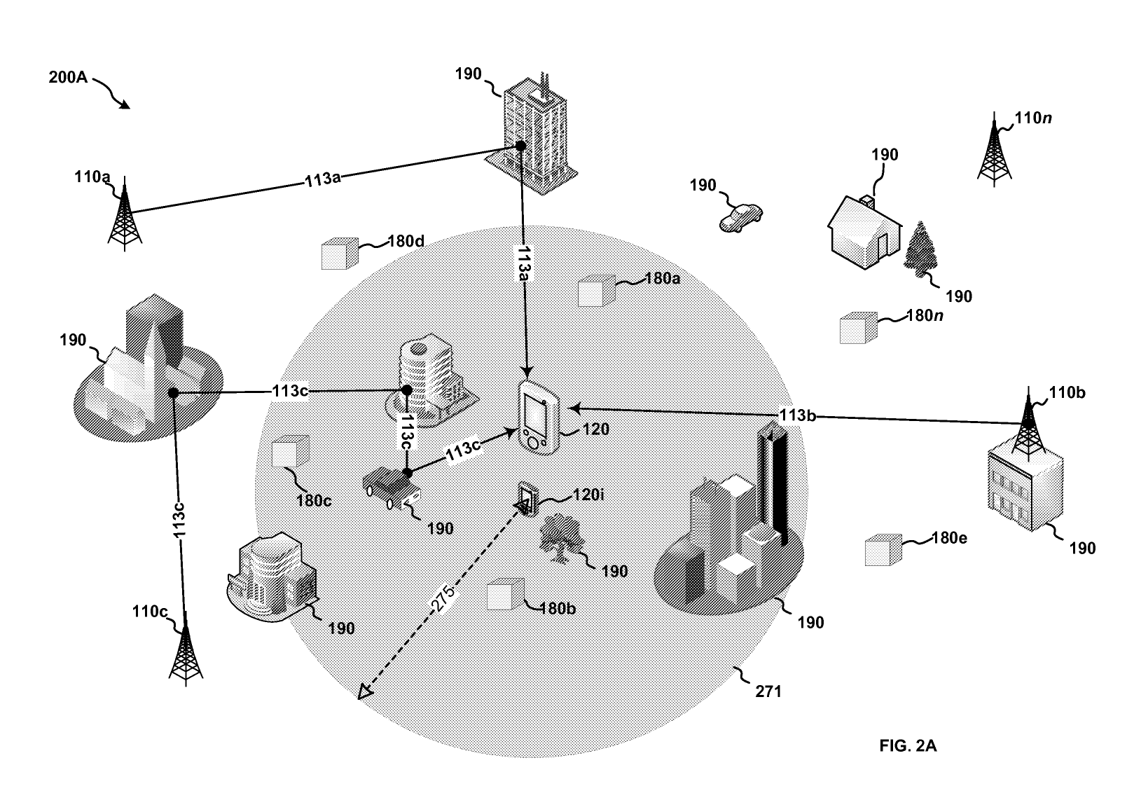

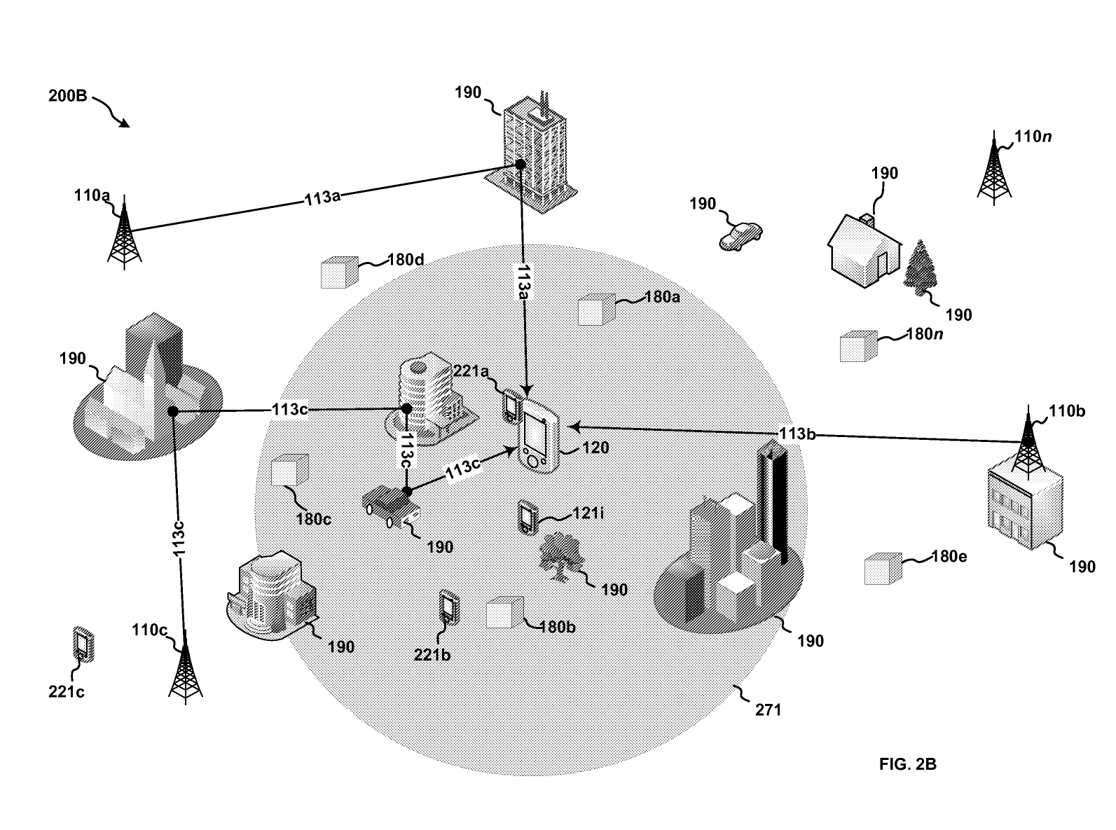

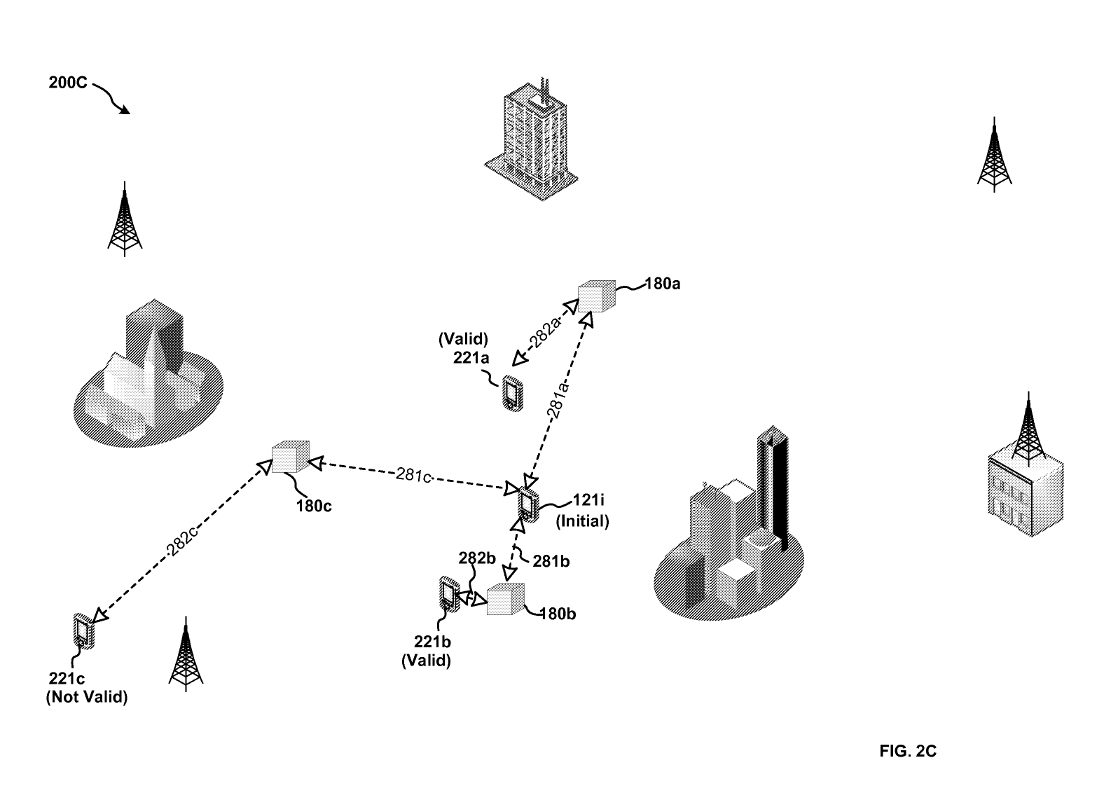

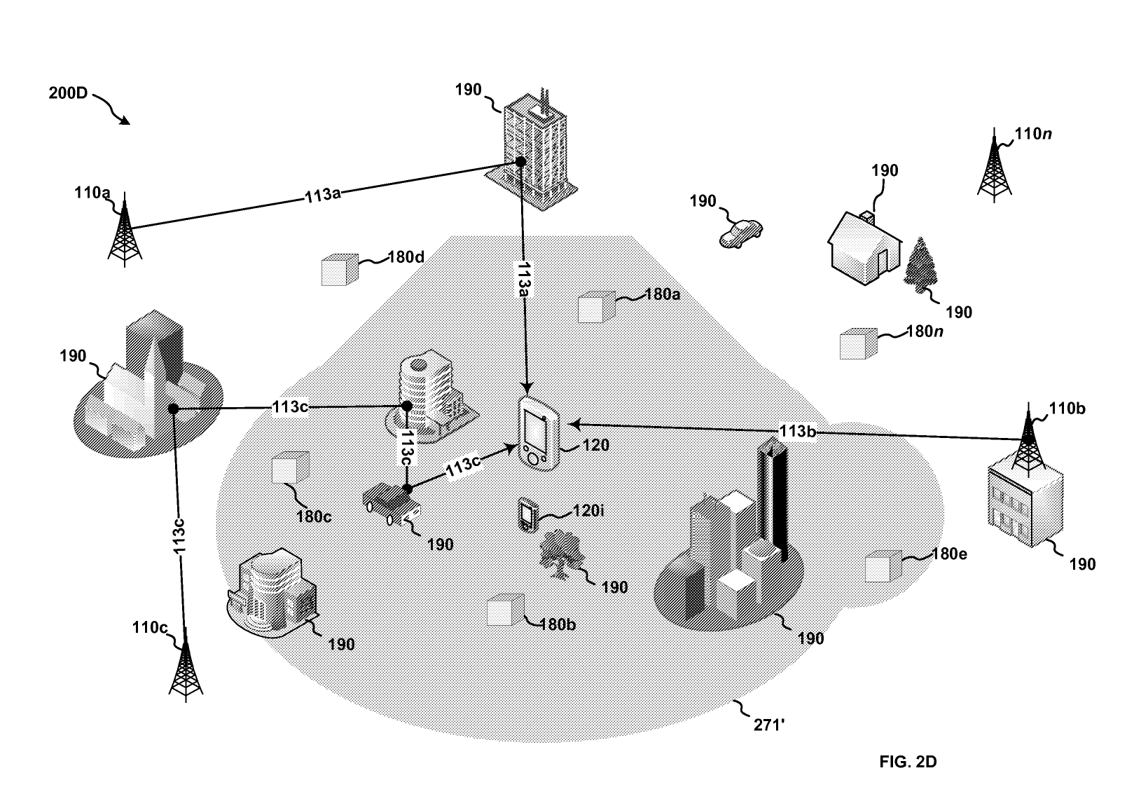

Attention is now drawn to FIG. 2A, which shows a reference vicinity of interest 271 defined by a distance of interest 275 from the initial estimate 121i. Although not shown, the reference vicinity of interest 271 may take on any number of shapes.

One purpose of the reference vicinity of interest 271 may be to identify reference locations of interest for use in computing other (and potentially improved) position estimates. As shown, reference locations 180a-c are within the distance of interest 275 from the initial estimate 121i, while other reference locations 180d-n fall outside of the reference vicinity of interest 271. As is discussed in further detail herein, reference locations that fall within the reference vicinity of interest 271 may be selected due to their proximity to the receiver 120 based on the initial estimate 121i.

The receiver 120 having an initial estimate 121i is aware that it is in a multipath environment, and wishes to utilize the nearby reference locations 180 to improve upon this estimate 120i. In order to do so, the receiver 120 forms a series of hypothesis tests utilizing data from each of these reference locations 180 together with its measured TOA data to refine its position location estimate. For example, the receiver may hypothesize that a particular nearby reference location 180 contains appropriate range error corrections (or other timing data adjustments). Applying these corrections to the measured TOA data results in a new location estimate 221, the quality of which may be evaluated by various means (such as the use of “range residuals” as discussed later). This hypothesis testing may be made for each of the reference locations 180 in the vicinity 271 of the receiver 120.

Attention is now drawn to FIG. 2B, which shows computation of other position estimates 221a-c associated with reference locations 180a-c. As is discussed in further detail herein, three different position estimates 221a-c may be based on TOA measurements associated with signal pathways 113a-c from transmitters 110a-c to the receiver 120, together with the timing data corresponding to reference locations 180a-c For example, multipath delay errors mentioned above with respect to FIG. 1D may be used to adjust the TOA measurements taken at the receiver 120, and the adjusted TOA measurements may be used to compute position estimates 221a-c. The quality of these estimates may be evaluated (e.g., using range residuals) to determine which if any are an improvement over the initial location estimate.

Attention is now drawn to FIG. 2C, which shows a methodology to filter position estimates 221a-c in order to determine which among the position estimates 221a-c are most accurate. As shown, distances 281a-c between reference locations a-c and the initial estimate 121i may be determined Additional distances 282a-c between reference locations a-c and the position estimates 221a-c may also be determined Again, these position estimates 221 are gotten by combining timing data corresponding to the reference locations 180 with the measured TOAs. Filtering may be applied based on various uses of the distances 281 and/or 282. In general, if a particular reference location 180 had applicable timing data for the receiver 120, then corrections associated with that reference location 180 should move the initial position estimate 121i toward that reference location 180.

By way of example, position estimate 221c associated with reference location 180c may be deemed invalid because the distance 282c exceeds the distance 281c or exceeds some threshold amount of distance. Another manner of approaching the comparison between position estimates 121i and 221c is to note that position estimate 221c is further away from the reference location 180, and as the new position estimate does not move the receiver 120's initial position estimate 121i closer to the reference location 180c.

By contrast, position estimate 221a may be deemed valid because the distance 282a is less than the distance 281a or does not exceed some threshold amount of distance. Another approach is to consider whether the position estimate 221a, as a new position estimate, moves the initial position estimate 121i closer to the reference location 180a.

Attention is now drawn to FIG. 2D, which shows a reference vicinity of interest 271′ with non-uniform boundaries. The unsymmetrical shape of the reference vicinity of interest 271′ may depend on various factors, including variations of multipath severity in system 200.

### Methodologies

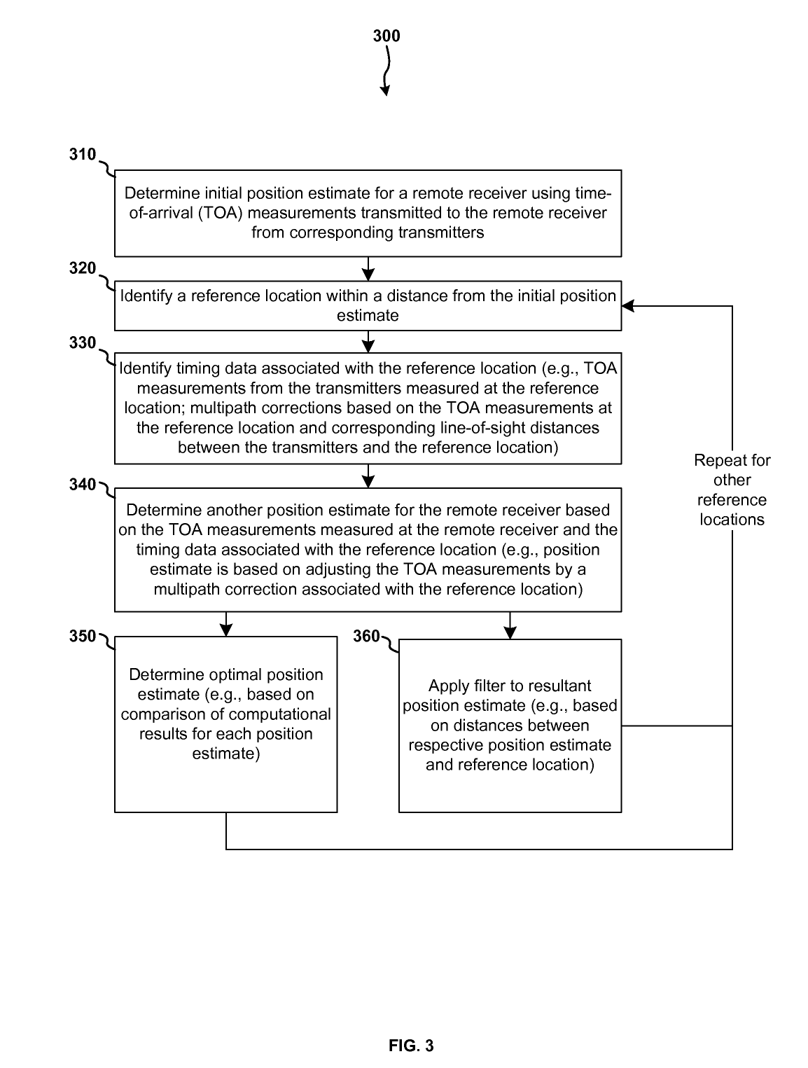

Various system features have been described above, including transmitters 110 and receivers 120. FIG. 3, described below and depicted in the Drawings, provide further details regarding certain implementations of various system components. Reference may be made to FIGS. 2A-D while describing the process illustrated in FIG. 3.

### Use of Timing Data to Determine Position

FIG. 3 illustrates a diagram detailing a process for using timing data associated with terrestrial transmitters (e.g., transmitters 110) and reference locations (e.g., reference locations 180) to compute position estimates (e.g., position estimates 221) for a remote receiver (e.g., receiver 120).

At stage 310, an initial position estimate 121i for a receiver 120 is determined using raw ranging data (e.g., TOA data) the receiver 120 acquired from transmitters 110. At stage 320 (with reference to FIG. 2A), a reference location 380 within a distance 275 from the initial position estimate 121i is identified. Accordingly, the initial position estimate 121i may be used to identify reference locations 180 that reside within a certain vicinity 271 of the initial position estimate 121i and therefore are potentially nearby the actual position of the receiver 120. The shape and size of the vicinity of interest 271 may take on various shapes and sizes that have definable boundaries, including spheres or other 3-dimension shapes. The shapes may vary if multipath severity varies within the system 200. For example, as shown in FIG. 2D, the boundaries of the vicinity of interest 271′ may vary from the boundaries of the vicinity of interest 271 of FIG. 2A where multipath severity varies within system 200D.

At stage 330, timing data associated with the reference location 380 may be identified. For example, such timing data may include TOA measurements associated with signals transmitted by the transmitters 110 and measured at the reference location 180, or multipath delay corrections based on the TOA measurements at the reference location 180 and corresponding line-of-sight distances between the transmitters 110 and the reference location 180).

At stage 340 (with reference to FIG. 2B), a position estimate 221 for the receiver 120 may be determined based on the TOA measurements at the receiver 120 and the timing data associated with the reference location 180. For example, the position estimate 221 may be based on adjusting the TOA measurements received at the receiver 120 by the multipath delay correction associated with multipath delay error measured at the reference location 180 for particular transmitters 110. The resultant adjusted TOA measurements may then be used to compute a position estimate 221.

Stages 320 through 350 may be repeated for other reference locations 380.

At stage 350, an iterative process may then be used to determine which timing data associated with respective reference locations 180n is the most appropriate timing data to apply to the raw range measurements for refining the positioning result of the receiver 120—that is, timing data for each reference location 180 is used to determine which reference location 180 is closest to the true location of the receiver 120. For example, an optimal position estimate from the position estimates 221 and 121i may be determined for each position estimate by a computation using the estimate together with the associated corrected TOA data, and the results of those computations for the set of all estimates may be compared to select the optimal position estimate. In particular, a range residual may be obtained for position estimates associated with each reference location 180, and the estimate that results in the smallest range residual may be selected as the optimal position estimate.

At stage 360 (with reference to FIG. 2C), resultant position estimates 221 may be filtered in a similar manner as is depicted in FIG. 2C and described elsewhere herein. Mainly, distances 282 between reference locations 180 and respective position estimates 221 may be evaluated in view of predefined conditions (e.g., not exceeding maximum distances; having some relational characteristic with respect to the initial position estimate 120i or distances 281 between the reference locations 180 and the initial position estimate 120i). Accordingly, filtering in stage 360 may be used to select the optimal position estimate where stage 350 would select an inaccurate position estimate 221 or associated timing data.

In one particular embodiment, a quantitative parameter called a positioning convergence metric (PCM) may be used to describe the trilateration positioning result variation trend before and after certain timing data is used (e.g., before or after multipath delay error corrections are applied). The PCM may be calculated for each of the reference locations 180 that falls into the vicinity of interest 271. In the PCM calculation, a distance 281 from the initial position estimate to the reference location 180 may be determined, and then compared to a calculated distance 282 from the updated position estimate 221 to the reference location 180. If distance 281 is large while distance 282 becomes significantly smaller, the PCM is large and the timing data for that reference location 180 may be deemed valid and appropriate. Otherwise, timing data associated with the reference location 180 may be deemed invalid and therefore not applied. FIG. 2C illustrates one implementation of a PCM approach for filtering timing data for reference locations 180.

Stages 320 through 340 and 360 may be repeated for other reference locations 380.

### Alternative Use of Timing Data to Determine Position

TOA measurements taken at the receiver 120 may be used to determine a time bias associated with the receiver 120, which may be used to adjust TOA measurements that were previously measured at the reference locations 180. Those adjusted TOA measurements may then be used to compute position estimates 221a-c. Yet another approach may involve selecting a preferred TOA measurement taken at the receiver 120, and then computing differences between that TOA measurement and remaining TOA measurements that were taken at the receiver 120. Similar differences may be computed for TOA measurements at each reference location, and then compared to the differences associated with TOA measurements that were taken at the receiver 120. These and other approaches are described in more detail below.

Alternative methodologies are contemplated compared to those described above with respect to FIG. 3. For example non-iterative methods may compare timing data at a particular reference location 180 to TOA measurements from the receiver 120. In order to compare the timing data and the TOA measurements, a nuisance parameter associated with unknown receiver time (e.g., time bias) of the receiver 120 may need to be accounted for. Accounting for time bias may be accomplished using various techniques.

For example, a maximum likelihood estimate of the time bias may be computed based on the transmission times of the transmitters, the TOA measurements at the receiver 120 and the timing data associated with a hypothesized reference location. The measured TOA' s are then modified with this estimated bias, effectively changing them from estimated pseudoranges to estimated true ranges. These estimates may then be compared to the expected TOA measurements at the reference location 180 based upon previously measured TOA measurements at the reference location 180. A metric such as an L1 norm or an L2 norm may then be used to quantify the difference between TOA measurements at the receiver 1220 and the expected TOA measurements at the reference location 180. A similar process may be repeated for other reference locations 180, and results of the metric may be compared to select optimal timing data associated with a particular reference location 180. By way of example, a result for a reference location 180 that corresponds to a minimum associated with the metric may be chosen as the optimal location estimate. Of course a different bias calculation is made for each reference location.

Alternatively, one of the TOA measurements received by the receiver 120 may be selected as the “strongest” range measurement from among the other TOA measurements. The selected TOA measurement may then be subtracted from each of the remaining TOA measurements, thereby producing a set of time differences that removes the common time bias from the receiver 120. Each of these time differences may then be compared with a corresponding set of time differences at each reference location 180. A metric such as an L1 norm or an L2 norm may then be used to quantify the comparison, and the reference location 180 yielding a preferred result may be chosen as the optimal position estimate.

Either of the above methodologies may further include a gradient-type algorithm that may be used to further refine the position estimate when the range measurement errors for each reference location are relatively constant over a small geographical distance.

### Collecting Timing Data

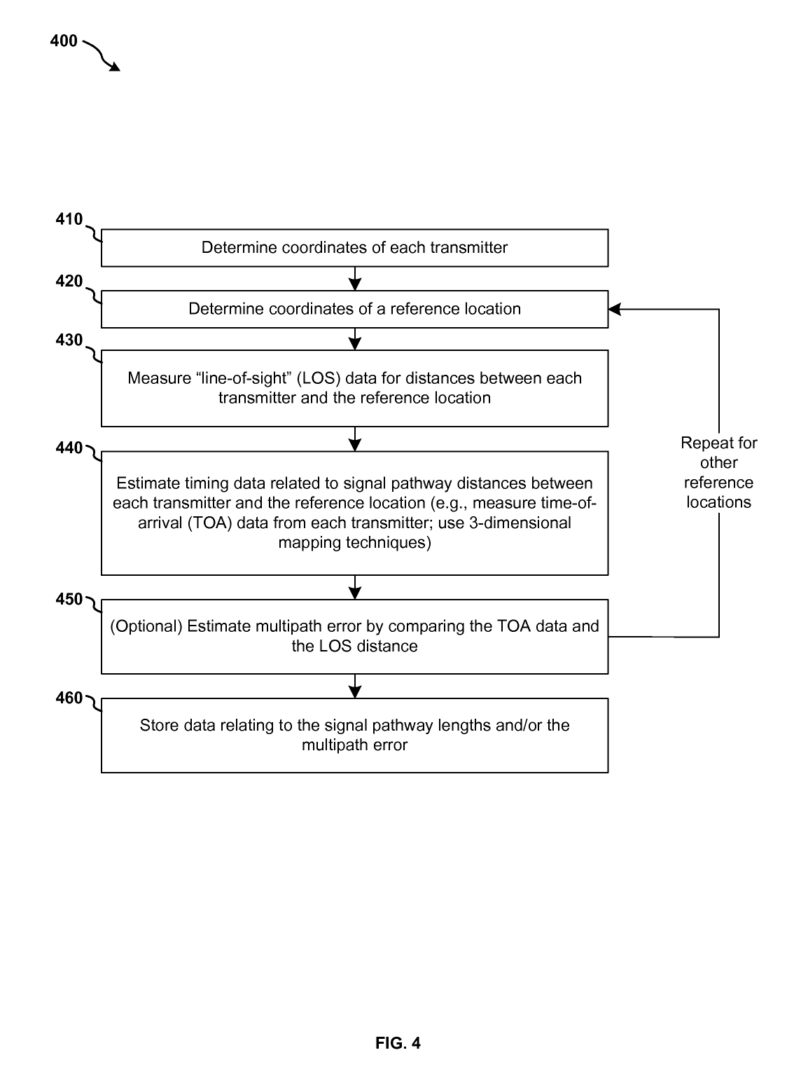

With reference to FIGS. 1C-D, attention is drawn to FIG. 4, which depicts a methodology 400 with steps for collecting timing data associated with terrestrial transmitters (e.g., transmitters 110) and reference locations (e.g., reference locations 180) that may be used to compute position estimates (e.g., position estimates 221) for a remote receiver (e.g., receiver 120).

At stages 410 and 420, coordinates of each transmitter 110 and a reference location 180 are determined The coordinates may be derived from previously mapped data, or may be determined using position location techniques (e.g., GPS and others).

At stage 430, “line-of-sight” (LOS) distances between each transmitter 110 and the reference location 180 are determined By way of example, distance 111a of FIG. 1B and distances 115a-c each depict LOS distances.

At stage 440, timing data associated with signal pathways between each transmitter 110 and the reference location 180 are estimated. One approach for estimated signal pathway lengths involved taking TOA measurements at the reference location 180. Another approach involves using 3-dimensional mapping techniques utilizing a geographical database to determine a shortest path from each transmitter 110 to the reference locations 180 around objects 190.) Stage 440 can be achieved by collecting signal propagation/range measurement data (e.g., TOA data) from each transmitter 110 at each reference location 180, and (optionally) comparing the distances associated with the measured TOA to LOS distances. If such surveying is not possible, stage 440 may be achieved by predicting the range measurement data using 3-dimensional models of objects 190 in system 100. Such objects 190 may be considered obstacles that wireless signals can only travel around, but not through. Thus, by considering a wireless ranging signal as a moving particle, certain embodiments of stage 440 may estimate a transmission path of a wireless ranging signal that propagates between a pair of transmitter and reference locations in complex urban areas. A shortest possible path that detours all intervening objects 190 (e.g., buildings, hills) on its way to a reference location 180 may be determined

At stage 450, multipath delay errors may be estimated by comparing the TOA measurements and the LOS distance. For example, the travel distance of a signal as determined in stage 440 may be compared with the expected travel distance of a LOS signal (as determined in stage 430), and the difference may be used to determine multipath delay errors for each signal from each transmitter 110 to each reference location 180.

Stages 420 through 450 may be repeated for other reference locations 180 that are preferable nearly uniformly distributed over system 100. In practice, however, the distribution is likely to be nonuniform. Separation of the reference locations 180 may depend on various factors, including the range measurement or error variation rate in the system 100, and locations of objects (e.g., where reference locations 180 may be located on all four sides of a tall building). The results from stages 440, 450 and/or 460 may be stored in a data source for later access by the remote receiver 120.

### Additional Aspects

Various other aspects are described below.

### Data Source of Timing Data Corresponding to Reference Locations

Certain aspects apply to personal mobile handsets in urban environments. In accordance with some embodiments, 3-dimensional modeling data relating to objects 190 (e.g., buildings) or survey data specifying range measurements at reference locations may be obtained prior to any deployment of a terrestrial positioning system comprising transmitters 110. However, stored modeling or survey data may be updated on a continuous basis or upon some change in the system 100 or 200 (e.g., removal or introduction of an object 190; removal or introduction of a transmitter 110).

Storage of the modeling or survey data may reside on a server that is accessible by the receiver 120, or on a local data source of the receiver 120. Access to the data source may be achieve through the terrestrial network of transmitters 110 or a local area network (e.g., Wi-Fi, Bluetooth, or other wireless network through various intervening computing devices such as routers, other receivers 120 or other devices).

In accordance with various aspects, the modeling or survey data may include position coordinates for each reference location 180 (e.g., latitude, longitude, and altitude), and may also include corresponding timing data for transmitter 110a through transmitter 110n. Position coordinates for each transmitter 110a-n may also be stored, or the LOS distance between each transmitter 110a-n and each reference location 180 may be stored.

It is further contemplated that timing data may be collected from other receivers over time.

### Example Computations Used for Determining Optimal Position Estimate

In at least one embodiment, selection of an optimal position estimate from among multiple position estimates may be accomplished using the following objective function, or a variation of it:

Σₗ₋ₙ(w[n]*|PR[n]−Distance[n]−tb|̂2),

where w[n] is a weight assigned to transmitter[n]; PR[n] represents the range measurements from the receiver; Distance[n] represents the distance between the reference location's position estimate and transmitter[n]; and tb represents time bias common to the PR[1]-[n]. The result of this objective function may be referred to as a residual. Residuals may be computed for each position estimate corresponding to each reference location. The position estimate and corresponding reference location resulting that has a preferred residual (e.g., smallest residual) may then be selected as the optimal position estimate.

### Processing of Range Measurements and Timing Data Associated with Reference Location

Various aspects relate different methodologies for processing range measurements transmitted from transmitters 110 to a receiver 120 in conjunction with timing data associated with a reference location 180 and the transmitters 110.

By way of example, one or more aspects may relate to systems (e.g., such systems with at least one processing component), methods and computer program products (e.g., such products comprising a non-transitory computer usable medium having a computer readable program code embodied therein) for improving a position location estimate in a time-of-arrival location system in which the location of remote receiver is determined from time of arrival measurements performed at the receiver from transmissions from a set of transmitters. The systems, methods and computer program products may carry out or otherwise implement any or all of the following method steps: obtain a database of timing data (e.g., time corrections) corresponding to a multiplicity of reference locations within a specified geographical area; obtain a first set of measurements corresponding to measured times-of-arrival of transmissions from transmitters to the remote receiver; combine the first set of measurements and data from said database to form a second set of measurements; and use the second set of measurements to compute a position location of said receiver.

By way of another example, one or more aspects may relate to systems (e.g., such systems with at least one processing component), methods and computer program products (e.g., such products comprising a non-transitory computer usable medium having a computer readable program code embodied therein) for determining a position location estimate for a remote receiver based on one or more time-of-arrival measurements transmitted from one or more transmitters and first timing data associated with the one or more transmitters in addition to one or more reference locations within a reference area of the remote receiver. The systems, methods and computer program products may carry out or otherwise implement any or all of the following method steps: determine an initial position estimate for a remote receiver based on one or more time-of-arrival measurements transmitted from one or more transmitters to the remote receiver; identify first timing data associated with the one or more transmitters and further associated with a first reference location within a predefined distance of the initial position estimate; and determine a first position estimate for the remote receiver based on the one or more time-of-arrival measurements and the first timing data associated with the first reference location. The first timing data may include one or more time corrections associated with the one or more transmitters and further associated with the first reference location. The first position estimate may be determined by adjusting the one or more one or more time-of-arrival measurements using the one or more time corrections.

The method steps may further or alternatively include various combinations of the following steps: determine a first distance between the first position estimate and the location of the first reference location; use the first distance to determine whether the initial position estimate may be a better estimate of a location of the remote receiver than the first position estimate; determine that the initial position estimate may be the better estimate of the location of the remote receiver than the first position estimate when the first distance exceeds a threshold amount of distance; determine an initial distance between the initial position estimate and the location of the first reference location; and determine that the first position estimate may be the better estimate of the location of the remote receiver than the initial position estimate when the initial distance exceeds the first distance by a threshold amount of distance.

The method steps may further or alternatively include various combinations of the following steps: determine the initial position estimate based on first and second time-of-arrival measurements transmitted from corresponding first and second transmitters to the remote receiver; identify first and second time corrections associated with the corresponding first and second transmitters and further associated with the first reference location; and determine the first position estimate based on the first and second time-of-arrival measurements and the first and second time corrections.

The method steps may further or alternatively include various combinations of the following steps: identify another set of one or more time corrections associated with the one or more transmitters and further associated with a second reference location within the predefined distance of the initial position estimate; and determine a second position estimate for the remote receiver based on the one or more time-of-arrival measurements and the other set of one or more time corrections associated with the second reference location.

The method steps may further or alternatively include various combinations of the following steps: determine that the first position estimate may be a better position estimate than other position estimates when a first result corresponding to a first application of an objective function to the first position estimate may be preferred over other results corresponding to other applications of the objective function to the other position estimates. The first result may be based on a first weighted difference between a first distance between the first position estimate and a location of a first transmitter, and a second distance may be based on the first time-of-arrival measurement. The first application of the objective function may use the first position estimate and one or more locations of the one or more transmitters to compute one or more values related to one or more distances between the first position estimate and one or more locations of the one or more transmitters, and then compare the computed one or more values to one or more other values associated with the one or more time-of-arrival measurements.

The one or more time corrections may correspond to one or more signal pathways from the one or more transmitters to the first reference location that extend around one or more objects positioned between each of the one or more transmitters and the first reference location.

The method steps may further or alternatively include various combinations of the following steps: determine the location of the first reference location; determine the location of a first transmitter from the one or more transmitters; determine a first line-of-sight distance between the first reference location and the first transmitter; estimate a first length of a first signal pathway between the first transmitter and the first reference location; compare the first line-of-sight distance with the first length; estimate, based on the comparison between the first line-of-sight distance and the first length, a first time correction of the one or more time corrections; and cause the first time correction to be stored in a data source. The first length may be estimated based on a first range measurement from the first transmitter to the first reference location, based on a first reference model of objects near the first transmitter or the first reference location, or based on one or more signal pathways around objects positioned between the first transmitter and the first reference location. The first line-of-sight distance and the first range measurement may be compared to determine if the first range measurement may be associated with a first multipath signal from the first transmitter to the first reference location. The first range measurement adjustment may be based on a difference between the first line-of-sight distance and the first length.

The first timing data may include a first set of one or more measured times-of-arrival associated with the one or more transmitters and the first reference location that were collected from the one or more transmitters at the first reference location prior to transmission of the one or more time-of-arrival measurements transmitted from one or more transmitters to the remote receiver. The method steps may further or alternatively include various combinations of the following steps: determine a maximum likelihood estimate of a time bias based on the one or more time-of-arrival measurements transmitted from the one or more transmitters to the remote receiver; determine a first set of one or more adjusted times-of-arrival associated with the first reference location and the one or more transmitters, wherein the first set of one or more adjusted times-of-arrival may be based on the maximum likelihood estimate of the time bias and the first set of one or more measured times-of-arrival; compute a first result based on the one or more time-of-arrival measurements and the first set of one or more adjusted times-of-arrival; determine the first position estimate based on the first result; identify second timing data including a second set of one or more measured times-of-arrival associated with the one or more transmitters and further associated with a second reference location within a predefined distance of the initial position estimate; determine a second set of one or more adjusted times-of-arrival associated with the second reference location and the one or more transmitters, wherein the second set of one or more adjusted times-of-arrival may be based on the maximum likelihood estimate of the time bias and the second set of one or more measured times-of-arrival; compute a second result based on the one or more time-of-arrival measurements and the second set of one or more adjusted times-of-arrival; and determine the first position estimate relates to the first reference location when the first result may be preferred over the second result.

The method steps may further or alternatively include various combinations of the following steps: identify a first time-of-arrival measurement transmitted from a first transmitter to the remote receiver; account for a common time bias among the one or more time-of-arrival measurements by subtracting the first time-of-arrival measurement from each of the one or more time-of-arrival measurements to produce one or more corresponding time differences, wherein the first timing data includes a first set of one or more other time differences corresponding to measured times-of-arrival associated with the one or more transmitters and the first reference location; compute a first result based on the one or more corresponding time differences and the first set of one or more other time differences; determine the first position estimate based on the first result; identify second timing data including a second set of one or more other time differences corresponding to measured times-of-arrival associated with the one or more transmitters and a second reference location within a predefined distance of the initial position estimate; computing a second result based on the one or more corresponding time differences and the second set of one or more other time differences; and determine the first position estimate relates to the first reference location when the first result may be preferred over the second result.

As previously described, the timing data may be stored for later use by the receiver 120. Accordingly, certain aspects relate to methodologies for collecting the timing data. By way of another example, certain aspects relate to systems and methods for determining an estimate of multipath-induced range measurement error relating to one or more reference points and one or more transmitters. The systems may implement one or more processing components operable to carry out the following method steps: determine a location of a first reference point; determine a location of a first transmitter; determine a first distance between the first reference point and the first transmitter; estimate a first length of a first signal pathway between the first transmitter and the first reference point; compare the first distance with the first length; estimate, based on the comparison between the first distance and the first length, a first range measurement error; and cause the first range measurement error to be stored in a data source.

The data source may be configured to store a first plurality of range measurement errors corresponding to the first transmitter and a plurality of reference points including the first reference point; or, may be configured to store a first plurality of range measurement errors corresponding to the first reference point and a plurality of transmitters including the first transmitter; or, may be configured to store a first plurality of range measurement errors corresponding to the first transmitter and a plurality of reference points including the first reference point and further configured to store a second plurality of range measurement errors corresponding to a second transmitter and the plurality of reference points.

The method steps may further or alternatively include various combinations of the following steps: determine a location of a second reference point; determine a second distance between the second reference point and the first transmitter; estimate a second length of a second signal pathway between the first transmitter and the second reference point; compare the second distance with the second length; estimate, based on the comparison between the second distance and the second length, a second range measurement error; and cause the second range measurement error to be stored in the data source.

The method steps may further or alternatively include various combinations of the following steps: determine a location of a second transmitter; determine a second distance between the first reference point and the second transmitter; estimate a second length of a second signal pathway between the second transmitter and the first reference point; compare the second distance with the second length; estimate, based on the comparison between the second distance and the second length, a second range measurement error; and cause the second range measurement error to be stored in the data source.

The first distance and the first range measurement may be compared to determine if the first range measurement may be associated with a first multipath signal from the first transmitter to the first reference point. The first range measurement error may be based on a difference between the first distance and the first length. The first distance may be determined using latitude, longitude, and altitude coordinates of the location of the first reference point in addition to using latitude, longitude, and altitude coordinates of the location of the first transmitter. The first length may be estimated based on a first range measurement from the first transmitter to the first reference point, based on a first spatial model of objects near the first transmitter and the first reference point, or based on one or more signal pathways around objects positioned between the first transmitter and the first reference point.

### Use of Other Position Data

The determination of an optimal position estimate can also be aided by other positioning resources when available. For example, a barometric altimeter can be used to filter out reference locations 180 that fall outside of an acceptable vertical direction.

### Use of Other Networks

The initial estimate of receiver location may be determined using initial location information selected from the group consisting of one or more terrestrial transmitter range measurements from a corresponding one or more terrestrial transmitters, one or more GPS range measurements from a corresponding one or more satellites, and one or more signals from one or more corresponding wireless local area networks within range of the receiver. In accordance with one aspect, the receiver may connect to a wireless local area network (e.g., Wi-Fi hotspot at a known or estimated location), and the location of the wireless LAN may be used to identify nearby reference points. Determination of the LAN's location may be accomplished using a reference data source that correlates identifying information about the LAN that is received by the receiver with a stored location of the LAN, or using location information broadcasted by the LAN. Alternatively, range measurements from a plurality of transmitters may be used to estimate the initial position, which may be used to identify reference points within a threshold distance of the receiver. Once the reference points are identified, the location of the Wi-Fi hotspot may be used to filter out locations of identified reference points that do not reside within a threshold distance from the Wi-Fi hotspot.

### Computation of Position Estimates

This disclosure contemplates various methods for computing a position estimate 121i or 221 for the receiver 120 using range measurements from transmitters 110 or elsewhere (e.g., the data source of timing data). For example, TOA data may be used during a trilateration processes to compute position estimates 121i and 221. One of skill in the art will appreciate that any method for computing a position estimate in a time-of-arrival system (e.g., terrestrial and satellite systems) is contemplated.

Timing data may also be used to weigh range measurements corresponding to particular transmitters. For example, timing data such as a multipath delay error can be used to weigh the corresponding adjusted range measurement for the corresponding transmitter at a reference location. If the multipath delay error is large, the corresponding adjusted range measurement may be weighed lower. By comparison, if the multipath delay error is small, the corresponding adjusted range measurement may be allocated a high weight. In a similar manner received range measurement SNRs may be used to weigh each range measurement, as part of the position location calculation. Other signal parameters, such as received multipath profile, may also be used in the weighting process.

### Supporting Aspects

Various aspects relate to disclosures of other patent applications, patent publications, or issued patents. For example, each of the following applications, publications, and patents are incorporated by reference in their entirety for any and all purposes: U.S. Utility patent application Ser. No. 13/412,487, entitled WIDE AREA POSITIONING SYSTEMS, filed on Mar. 5, 2012; U.S. Utility patent application Ser. No. 12/557,479 (now U.S. Pat. No. 8,130,141), entitled WIDE AREA POSITIONING SYSTEM, filed Sep. 10, 2009; U.S. Utility patent application Ser. No. 13/412,508, entitled WIDE AREA POSITIONING SYSTEM, filed Mar. 5, 2012; U.S. Utility patent application Ser. No. 13/296,067, entitled WIDE AREA POSITIONING SYSTEMS, filed Nov. 14, 2011; Application Serial No. PCT/US12/44452, entitled WIDE AREA POSITIONING SYSTEMS (WAPS), filed Jun. 28, 2011); U.S. patent application Ser. No. 13/535,626, entitled CODING IN WIDE AREA POSITIONING SYSTEMS (WAPS), filed Jun. 28, 2012; U.S. patent application Ser. No. 13/565,732, entitled CELL ORGANIZATION AND TRANSMISSION SCHEMES IN A WIDE AREA POSITIONING SYSTEM (WAPS), filed Aug. 2, 2012; U.S. patent application Ser. No. 13/565,723, entitled CELL ORGANIZATION AND TRANSMISSION SCHEMES IN A WIDE AREA POSITIONING SYSTEM (WAPS), filed Aug. 2, 2012. The above applications, publications and patents may be individually or collectively referred to herein as “incorporated reference(s)”, “incorporated application(s)”, “incorporated publication(s)”, “incorporated patent(s)” or otherwise designated. The various aspect, details, devices, systems, and methods disclosed herein may be combined with disclosures in any of the incorporated references in accordance with various embodiments.

This disclosure relates generally to positioning systems and methods for providing signaling for position determination and determining high accuracy position/location information using a wide area transmitter array of transmitters in communication with receivers such as in cellular phones or other portable devices with processing components, transceiving capabilities, storage, input/output capabilities, and other features.

Positioning signaling services associated with certain aspects may utilize broadcast-only transmitters that may be configured to transmit encrypted positioning signals. The transmitters (which may also be denoted herein as “towers” or “beacons”) may be configured to operate in an exclusively licensed or shared licensed/unlicensed radio spectrum; however, some embodiments may be implemented to provide signaling in unlicensed shared spectrum. The transmitters 110 may transmit signaling in these various radio bands using novel signaling as is described herein or in the incorporated references. This signaling may be in the form of a proprietary signal configured to provide specific data in a defined format advantageous for location and navigation purposes. For example, the signaling may be structured to be particularly advantageous for operation in obstructed environments, such as where traditional satellite position signaling is attenuated and/or impacted by reflections, multipath, and the like. In addition, the signaling may be configured to provide fast acquisition and position determination times to allow for quick location determination upon device power-on or location activation, reduced power consumption, and/or to provide other advantages.

The receivers may be in the form of one or more user devices, which may be any of a variety of electronic communication devices configured to receive signaling from the transmitters, as well as optionally be configured to receive GPS or other satellite system signaling, cellular signaling, Wi-Fi signaling, Wi-Max signaling, Bluetooth, Ethernet, and/or other data or information signaling as is known or developed in the art. The receivers may be in the form of a cellular or smart phone, a tablet device, a PDA, a notebook or other computer system, and/or similar or equivalent devices. In some embodiments, the receivers may be a standalone location/positioning device configured solely or primarily to receive signals from the transmitters and determine location/position based at least in part on the received signals. As described herein, receivers may also be denoted herein as “User Equipment” (UE), handsets, smart phones, tablets, and/or simply as a “receiver.”

The transmitters may be configured to send transmitter output signals to multiple receiver units (e.g., a single receiver unit is shown in certain figures for simplicity; however, a typical system will be configured to support many receiver units within a defined coverage area) via communication links). The transmitters may also be connected to a server system via communication links, and/or may have other communication connections to a network infrastructure, such as via wired connections, cellular data connections, Wi-Fi, Wi-Max, or other wireless connections, and the like.

Various embodiments of a wide area positioning system (WAPS), described herein or in the incorporated references, may be combined with other positioning systems to provide enhanced location and position determination. Alternately, or in addition, a WAPS system may be used to aid other positioning systems. In addition, information determined by receivers of WAPS systems may be provided via other communication network links, such as cellular, Wi-Fi, pager, and the like, to report position and location information to a server system or systems, as well as to other networked systems existing on or coupled to network infrastructure.

For example, in a cellular network, a cellular backhaul link may be used to provide information from receivers to associated cellular carriers and/or others via network infrastructure. This may be used to quickly and accurately locate the position of receiver during an emergency, or may be used to provide location-based services or other functions from cellular carriers or other network users or systems.

It is noted that, in the context of this disclosure, a positioning system is one that localizes one or more of latitude, longitude, and altitude coordinates, which may also be described or illustrated in terms of one, two, or three dimensional coordinate systems (e.g., x, y, z coordinates, angular coordinates, vectors, and other notations). In addition, it is noted that whenever the term ‘GPS’ is referred to, it is done so in the broader sense of Global Navigation Satellite Systems (GNSS) which may include other existing satellite positioning systems such as GLONASS as well as future positioning systems such as Galileo and Compass/Beidou. In addition, as noted previously, in some embodiments other positioning systems, such as terrestrially based systems, may be used in addition to or in place of satellite-based positioning systems.

Embodiments of WAPS include multiple transmitters configured to broadcast WAPS data positioning information, and/or other data or information, in transmitter output signals to the receivers. The positioning signals may be coordinated so as to be synchronized across all transmitters of a particular system or regional coverage area, and may use a disciplined GPS clock source for timing synchronization. WAPS data positioning transmissions may include dedicated communication channel resources (e.g., time, code and/or frequency) to facilitate transmission of data required for trilateration, notification to subscriber/group of subscribers, broadcast of messages, and/or general operation of the WAPS network. Additional disclosure regarding WAPS data positioning transmissions may be found in the incorporated applications.

In a positioning system that uses time difference of arrival or trilateration, the positioning information typically transmitted includes one or more of precision timing sequences and positioning signal data, where the positioning signal data includes the location of transmitters and various timing corrections and other related data or information. In one WAPS embodiment, the data may include additional messages or information such as notification/access control messages for a group of subscribers, general broadcast messages, and/or other data or information related to system operation, users, interfaces with other networks, and other system functions. The positioning signal data may be provided in a number of ways. For example, the positioning signal data may be modulated onto a coded timing sequence, added or overlaid over the timing sequence, and/or concatenated with the timing sequence.

Data transmission methods and apparatus described herein may be used to provide improved location information throughput for the WAPS. In particular, higher order modulation data may be transmitted as a separate portion of information from pseudo-noise (PN) ranging data. This may be used to allow improved acquisition speed in systems employing CDMA multiplexing, TDMA multiplexing, or a combination of CDMA/TDMA multiplexing. The disclosure herein is illustrated in terms of WAPS in which multiple towers broadcast synchronized positioning signals to UEs and, more particularly, using towers that are terrestrial. However, the embodiments are not so limited, and other systems within the spirit and scope of the disclosure may also be implemented.

In an exemplary embodiment, a WAPS uses coded modulation sent from a tower or transmitter, such as transmitter, called spread spectrum modulation or pseudo-noise (PN) modulation, to achieve wide bandwidth. The corresponding receiver unit, such as receiver, includes one or more modules to process such signals using a despreading circuit, such as a matched filter or a series of correlators, for example. Such a receiver produces a waveform which, ideally, has a strong peak surrounded by lower level energy. The time of arrival of the peak represents the time of arrival of the transmitted signal at the receiver. Performing this operation on a multiplicity of signals from a multiplicity of towers, whose locations are accurately known, allows determination of the receivers location via trilateration. Various additional details related to WAPS signal generation in a transmitter, along with received signal processing in a receiver are described herein or in the incorporated references.

Ttransmitters may include various blocks for performing associated signal reception and/or processing. For example, a transmitter may include one or more GPS modules for receiving GPS signals and providing location information and/or other data, such as timing data, dilution of precision (DOP) data, or other data or information as may be provided from a GPS or other positioning system, to a processing module. Other modules for receiving satellite or terrestrial signals and providing similar or equivalent output signals, data, or other information may alternately be used in various embodiments. GPS or other timing signals may be used for precision timing operations within transmitters and/or for timing correction across the WAPS network.

Transmitters may also include one or more transmitter modules (e.g., RF transmission blocks) for generating and sending transmitter output signals as described subsequently herein. A transmitter module may also include various elements as are known or developed in the art for providing output signals to a transmit antenna, such as analog or digital logic and power circuitry, signal processing circuitry, tuning circuitry, buffer and power amplifiers, and the like. Signal processing for generating the output signals may be done in the a processing module which, in some embodiments, may be integrated with another module or, in other embodiments, may be a standalone processing module for performing multiple signal processing and/or other operational functions.

One or more memories may be coupled with a processing module to provide storage and retrieval of data and/or to provide storage and retrieval of instructions for execution in the processing module. For example, the instructions may be instructions for performing the various processing methods and functions described subsequently herein, such as for determining location information or other information associated with the transmitter, such as local environmental conditions, as well as to generate transmitter output signals to be sent to the user devices.

Transmitters may further include one or more environmental sensing modules for sensing or determining conditions associated with the transmitter, such as, for example, local pressure, temperature, or other conditions. In an exemplary embodiment, pressure information may be generated in the environmental sensing module and provided to a processing module for integration with other data in transmitter output signals as described subsequently herein. One or more server interface modules may also be included in a transmitter to provide an interface between the transmitter and server systems, and/or to a network infrastructure.

Receivers may include one or more GPS/ modules for receiving GPS signals and providing location information and/or other data, such as timing data, dilution of precision (DOP) data, or other data or information as may be provided from a GPS or other positioning system, to a processing module (not shown). Of course, other Global Navigation Satellite Systems (GNSS) are contemplated, and it is to be understood that disclosure relating to GPS may apply to these other systems. Of course, any location processor may be adapted to receive and process position information described herein or in the incorporated references.

Receiver may also include one or more cellular modules for sending and receiving data or information via a cellular or other data communications system. Alternately, or in addition, receiver may include communications modules for sending and/or receiving data via other wired or wireless communications networks, such as Wi-Fi, Wi-Max, Bluetooth, USB, or other networks.

Receiver may include one or more position/location modules for receiving signals from terrestrial transmitters, and processing the signals to determine position/location information as described subsequently herein. A position module may be integrated with and/or may share resources such as antennas, RF circuitry, and the like with other modules. For example, a position module and a GPS module may share some or all radio front end (RFE) components and/or processing elements. A processing module may be integrated with and/or share resources with the position module and/or GPS module to determine position/location information and/or perform other processing functions as described herein. Similarly, a cellular module may share RF and/or processing functionality with an RF module and/or processing module. A local area network (LAN) module may also be included.

One or more memories may be coupled with processing module and other modules to provide storage and retrieval of data and/or to provide storage and retrieval of instructions for execution in the processing module. For example, the instructions may perform the various processing methods and functions described herein or in the incorporated references.

Receiver may further include one or more environmental sensing modules (e.g., inertial, atmospheric and other sensors) for sensing or determining conditions associated with the receiver, such as, for example, local pressure, temperature, movement, or other conditions, that may be used to determine the location of the receiver. In an exemplary embodiment, pressure information may be generated in such an environmental sensing module for use in determining location/position information in conjunction with received transmitter, GPS, cellular, or other signals.

Receiver may further include various additional user interface modules, such as a user input module which may be in the form of a keypad, touchscreen display, mouse, or other user interface element. Audio and/or video data or information may be provided on an output module (not shown), such as in the form or one or more speakers or other audio transducers, one or more visual displays, such as touchscreens, and/or other user I/O elements as are known or developed in the art. In an exemplary embodiment, such an output module may be used to visually display determined location/position information based on received transmitter signals, and the determined location/position information may also be sent to a cellular module to an associated carrier or other entity.

The receiver may include a signal processing block that comprises a digital processing block configured to demodulate the received RF signal from the RF module, and also to estimate time of arrival (TOA) for later use in determining location. The signal processing block may further include a pseudorange generation block and a data processing block. The pseudorange generation block may be configured to generate “raw’ positioning pseudorange data from the estimated TOA, refine the pseudorange data, and to provide that pseudorange data to the position engine, which uses the pseudorange data to determine the location of the receiver. The data processing block may be configured to decode the position information, extract packet data from the position information and perform error correction (e.g., CRC) on the data. A position engine of a receiver may be configured to process the position information (and, in some cases, GPS data, cell data, and/or LAN data) in order to determine the location of the receiver within certain bounds (e.g., accuracy levels, etc.). Once determined, location information may be provided to applications. One of skill in the art will appreciate that the position engine may signify any processor capable of determining location information, including a GPS position engine or other position engine.

### Variations of Implementation

The various components, modules, and functions described herein can be located together or in separate locations. Communication paths couple the components and include any medium for communicating or transferring files among the components. The communication paths include wireless connections, wired connections, and hybrid wireless/wired connections. The communication paths also include couplings or connections to networks including local area networks (LANs), metropolitan area networks (MANs), wide area networks (WANs), proprietary networks, interoffice or backend networks, and the Internet. Furthermore, the communication paths include removable fixed mediums like floppy disks, hard disk drives, and CD-ROM disks, as well as flash RAM, Universal Serial Bus (USB) connections, RS-232 connections, telephone lines, buses, and electronic mail messages.

Aspects of the systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the systems and methods include: microcontrollers with memory (such as electronically erasable programmable read only memory (EEPROM)), embedded microprocessors, firmware, software, etc. Furthermore, aspects of the systems and methods may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that any system, method, and/or other components disclosed herein may be described using computer aided design tools and expressed (or represented), as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, HTTPs, FTP, SMTP, WAP, etc.). When received within a computer system via one or more computer-readable media, such data and/or instruction-based expressions of the above described components may be processed by a processing entity (e.g., one or more processors) within the computer system in conjunction with execution of one or more other computer programs.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import, when used in this application, refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments of the systems and methods is not intended to be exhaustive or to limit the systems and methods to the precise forms disclosed. While specific embodiments of, and examples for, the systems and methods are described herein for illustrative purposes, various equivalent modifications are possible within the scope of the systems and methods, as those skilled in the relevant art will recognize. The teachings of the systems and methods provided herein can be applied to other systems and methods, not only for the systems and methods described above. The elements and acts of the various embodiments described above can be combined to provide further embodiments. These and other changes can be made to the systems and methods in light of the above detailed description.

One of skill in the art will appreciate that the processes shown in the Drawings and described herein are illustrative, and that there is no intention to limit this disclosure to the order of stages shown. Accordingly, stages may be removed and rearranged, and additional stages that are not illustrated may be carried out within the scope and spirit of the invention.

In one or more exemplary embodiments, the functions, methods and processes described may be implemented in whole or in part in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer.

By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The various illustrative logical blocks, modules, processes, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps or stages of a method, process or algorithm in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure. Thus, the disclosure is not intended to be limited to the aspects shown herein but is to be accorded the widest scope consistent with the appended claims and their equivalents.

As used herein, computer program products comprising computer-readable media including all forms of computer-readable medium except, to the extent that such media is deemed to be non-statutory, transitory propagating signals.

While various embodiments of the present invention have been described in detail, it may be apparent to those skilled in the art that the present invention can be embodied in various other forms not specifically described herein. Therefore, the protection afforded the present invention should only be limited in accordance with the following claims.

1. A system configured to determine a position location estimate for a remote receiver based on one or more time-of-arrival measurements transmitted from one or more transmitters and first timing data associated with the one or more transmitters and further associated with one or more reference locations within a reference area of the remote receiver, the system comprising:
one or more processing components operable to:
determine an initial position estimate for a remote receiver based on one or more time-of-arrival measurements transmitted from one or more transmitters to the remote receiver;
identify first timing data associated with the one or more transmitters and further associated with a first reference location within a predefined distance of the initial position estimate; and
determine a first position estimate for the remote receiver based on the one or more time-of-arrival measurements and the first timing data associated with the first reference location.

2. The system of claim 1, wherein the first timing data includes one or more time corrections associated with the one or more transmitters and further associated with the first reference location.

3. The system of claim 2, wherein the first position estimate is determined by adjusting the one or more one or more time-of-arrival measurements using the one or more time corrections.

4. The system of claim 2, wherein the one or more processing components are further operable to:
determine a first distance between the first position estimate and the location of the first reference location; and
use the first distance to determine whether the initial position estimate is a better estimate of a location of the remote receiver than the first position estimate.

5. The system of claim 2, wherein the one or more processing components are further operable to:
determine the initial position estimate based on first and second time-of-arrival measurements transmitted from corresponding first and second transmitters to the remote receiver;
identify first and second time corrections associated with the corresponding first and second transmitters and further associated with the first reference location; and
determine the first position estimate based on the first and second time-of-arrival measurements and the first and second time corrections.

6. The system of claim 2, wherein the one or more processing components are further operable to:
identify another set of one or more time corrections associated with the one or more transmitters and further associated with a second reference location within the predefined distance of the initial position estimate; and
determine a second position estimate for the remote receiver based on the one or more time-of-arrival measurements and the other set of one or more time corrections associated with the second reference location.

7. The system of claim 1, wherein the one or more processing components are operable to:
determine that the first position estimate is a better position estimate than other position estimates when a first result corresponding to a first application of an objective function to the first position estimate is preferred over other results corresponding to other applications of the objective function to the other position estimates.

8. The system of claim 2, wherein the one or more time corrections correspond to one or more signal pathways from the one or more transmitters to the first reference location that extend around one or more objects positioned between each of the one or more transmitters and the first reference location.

9. The system of claim 2, wherein the one or more processing components are further operable to:
determine the location of the first reference location;
determine the location of a first transmitter from the one or more transmitters;
determine a first line-of-sight distance between the first reference location and the first transmitter;
estimate a first length of a first signal pathway between the first transmitter and the first reference location;
compare the first line-of-sight distance with the first length;
estimate, based on the comparison between the first line-of-sight distance and the first length, a first time correction of the one or more time corrections; and
cause the first time correction to be stored in a data source.

10. The system of claim 4, wherein the one or more processing components are further operable to:
determine that the initial position estimate is the better estimate of the location of the remote receiver than the first position estimate when the first distance exceeds a threshold amount of distance.

11. The system of claim 7, wherein the first result is based on a first weighted difference between a first distance between the first position estimate and a location of a first transmitter, and a second distance based on the first time-of-arrival measurement.

12. The system of claim 7, wherein the first application of the objective function uses the first position estimate and one or more locations of the one or more transmitters to compute one or more values related to one or more distances between the first position estimate and one or more locations of the one or more transmitters, and then compares the computed one or more values to one or more other values associated with the one or more time-of-arrival measurements.

13. The system of claim 9, wherein the first length is estimated based on a first range measurement from the first transmitter to the first reference location.

14. The system of claim 9, wherein the first length is estimated based on a first reference model of objects near the first transmitter or the first reference location.

15. The system of claim 9, wherein the first range measurement adjustment is based on a difference between the first line-of-sight distance and the first length.

16. A method for determining a position location estimate for a remote receiver based on one or more time-of-arrival measurements transmitted from one or more transmitters and first timing data associated with the one or more transmitters and further associated with one or more reference locations within a reference area of the remote receiver, the method comprising the following steps:
determine an initial position estimate for a remote receiver based on one or more time-of-arrival measurements transmitted from one or more transmitters to the remote receiver;
identify first timing data associated with the one or more transmitters and further associated with a first reference location within a predefined distance of the initial position estimate; and
determine a first position estimate for the remote receiver based on the one or more time-of-arrival measurements and the first timing data associated with the first reference location.

17. The method of 16, wherein the first timing data includes one or more time corrections associated with the one or more transmitters and further associated with the first reference location, said method further comprising the following steps:
determine the initial position estimate based on first and second time-of-arrival measurements transmitted from corresponding first and second transmitters to the remote receiver;
identify first and second time corrections associated with the corresponding first and second transmitters and further associated with the first reference location;
determine the first position estimate based on the first and second time-of-arrival measurements and the first and second time corrections;
identify another set of time corrections associated with the corresponding first and second transmitters and further associated with the second reference location within the predefined distance of the initial position estimate;
determine a second position estimate for the remote receiver based on the first and second time-of-arrival measurements and the other set of one or more time corrections associated with the second reference location; and
determine that the first position estimate is a better position estimate than the second position estimate when a first result corresponding to a first application of an objective function to the first position estimate is preferred over a second application of the objective function to the second position estimate.

18. The method of 17, said method further comprising the following steps:
determine the location of the first reference location;
determine the location of a first transmitter from the one or more transmitters;
determine a first line-of-sight distance between the first reference location and the first transmitter;
estimate a first length of a first signal pathway between the first transmitter and the first reference location;
compare the first line-of-sight distance with the first length;
estimate, based on the comparison between the first line-of-sight distance and the first length, a first time correction of the one or more time corrections; and
cause the first time correction to be stored in a data source.
